(19) United States
(12) Patent Application Publication
(10) Pub. No.: US 2025/0049626 A1
(43) Pub. Date: Feb. 13, 2025

(54) WALL MOUNTED BACK TREATMENT APPARATUS

(71) Applicant: Michael Castro, Visalia, CA (US)

(72) Inventor: Michael Castro, Visalia, CA (US)

(21) Appl. No.: 18/231,314

(22) Filed: Aug. 8, 2023

(51) Int. Cl. A61H 7/00; A61H 15/02; A61H 23/00

(52) U.S. Cl. CPC A61H 7/002; A61H 15/02; A61H 23/006; A61H 2015/0014; A61H 2015/0028; A61H 2201/0126; A61H 2201/013; A61H 2201/02; A61H 2201/1253; A61H 2201/1685; A61H 2201/1695; A61H 2205/081

(57) ABSTRACT

A back treatment assembly for providing a surface for treating a user's back, such as by facilitating scrubbing, scratching, massaging, or heat treating the back. includes a frame comprising a rear wall, a first lateral wall, and a second lateral wall. The rear wall is coupled to and extends between the first and second lateral walls, and each of the first and second lateral walls extends forwardly from the rear wall. A back engagement member is mounted to the frame and extends between the first and second lateral walls. The back engagement member is configured to abut a back of a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to back treatment apparatuses and more particularly pertains to a new back treatment apparatus for providing a surface for treating a user's back, such as by facilitating scrubbing, scratching, massaging, or heat treating the back.

### (2) Description of Related Art Including Information Disclosed Under 37 CFR 1.97 and 1.98

The prior art describes myriad back treatment apparatuses which are mountable to a wall to facilitate treating a user's back by facilitating massaging or scratching the back. However, the prior art fails to describe such an apparatus which comprises a mount which includes a back engagement member which mounts to a frame and extends between a pair of lateral walls of the frame and which is engageable with the user's back. The prior art also fails to disclose such an apparatus with interchangeable back engagement members and in which the frame attaches to a wall via fasteners or suction cups or attaches to a column via a strap.

### BRIEF SUMMARY OF THE INVENTION

An embodiment of the disclosure meets the needs presented above by generally comprising a frame comprising a rear wall, a first lateral wall, and a second lateral wall.

The rear wall is coupled to and extends between the first and second lateral walls, and each of the first and second lateral walls extends forwardly from the rear wall. A back engagement member is mounted to the frame and extends between the first and second lateral walls. The back engagement member is configured to abut a back of a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a back treatment assembly according to an embodiment of the disclosure.

FIG. 2 is a front perspective view of a mount assembly of an embodiment of the disclosure.

FIG. 3 is a rear perspective view of the mount assembly of an embodiment of the disclosure.

FIG. 4 is a rear perspective view of the mount assembly of an embodiment of the disclosure.

FIG. 5 is a front perspective view of a frame of an embodiment of the disclosure.

FIG. 6 is a rear perspective view of the frame of an embodiment of the disclosure.

FIG. 7 is a bottom exploded view of the mount assembly and the frame of an embodiment of the disclosure.

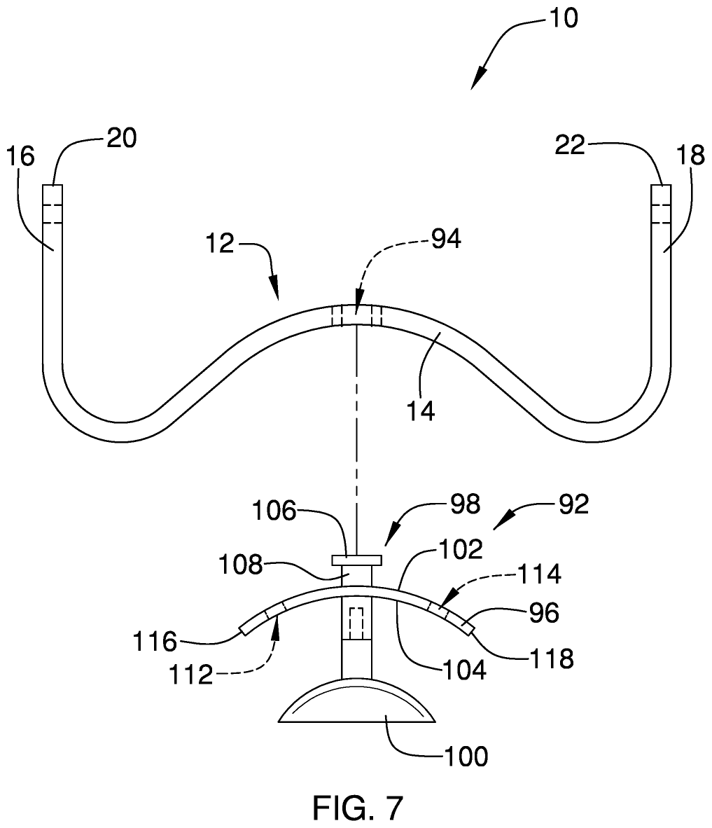

FIG. 8 is a perspective exploded view of the mount assembly and the frame of an embodiment of the disclosure.

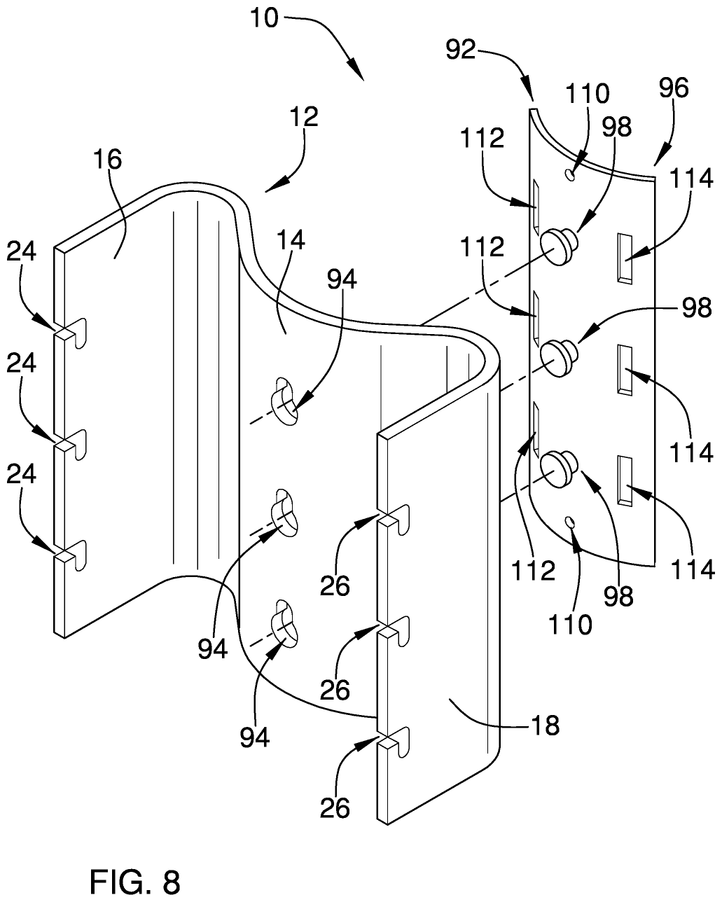

FIG. 9 is a perspective exploded view of the frame, the mount assembly, and a back engagement member of an embodiment of the disclosure.

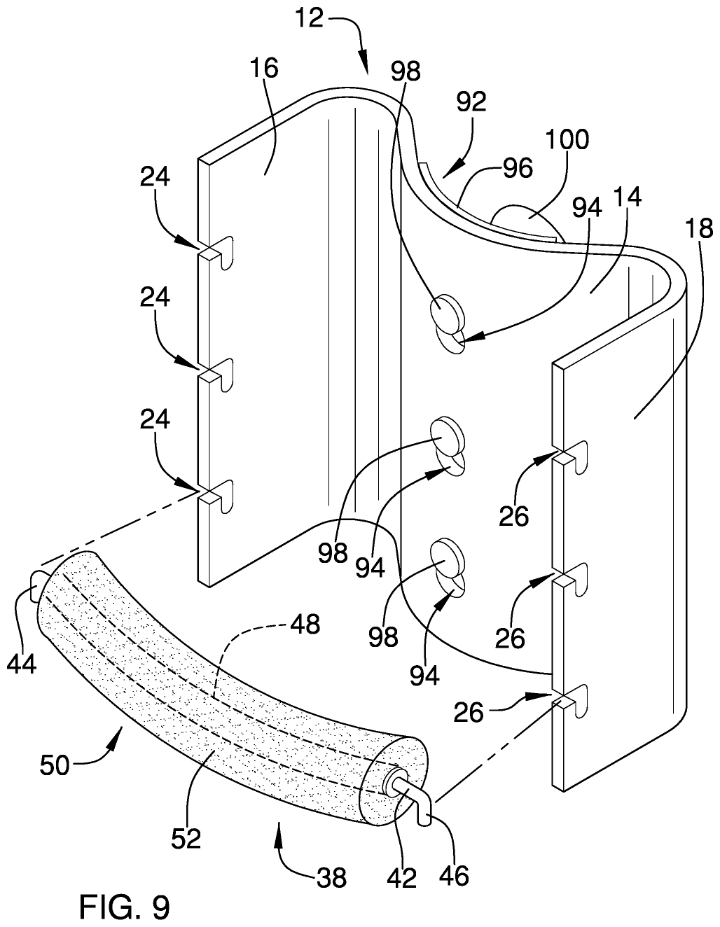

FIG. 10 is an in-use view of an embodiment of the disclosure.

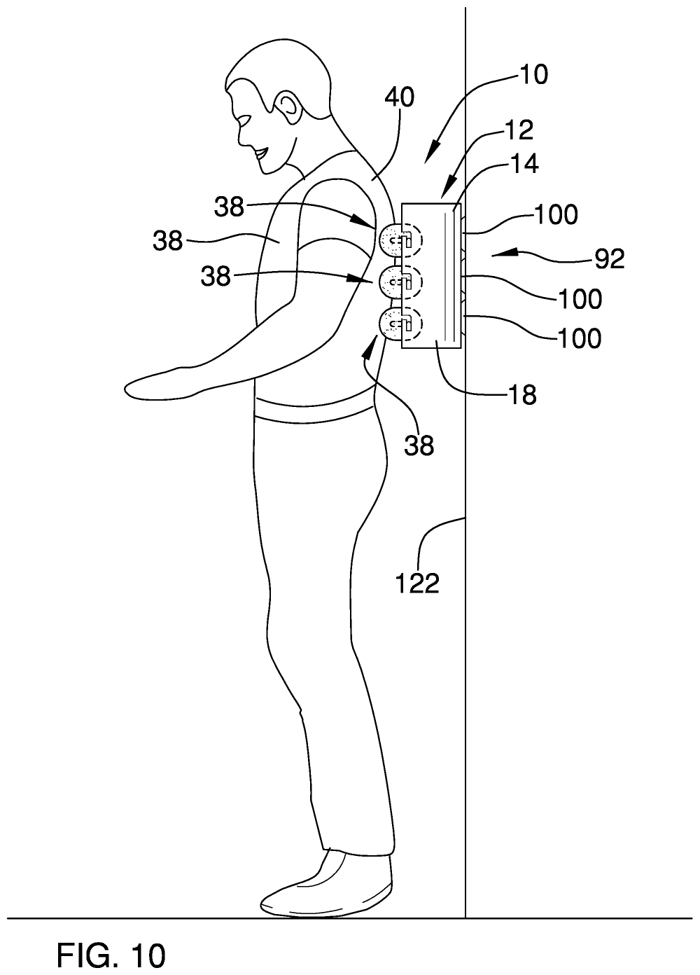

FIG. 11 is a kit view of some of a plurality of back engagement members of an embodiment of the disclosure.

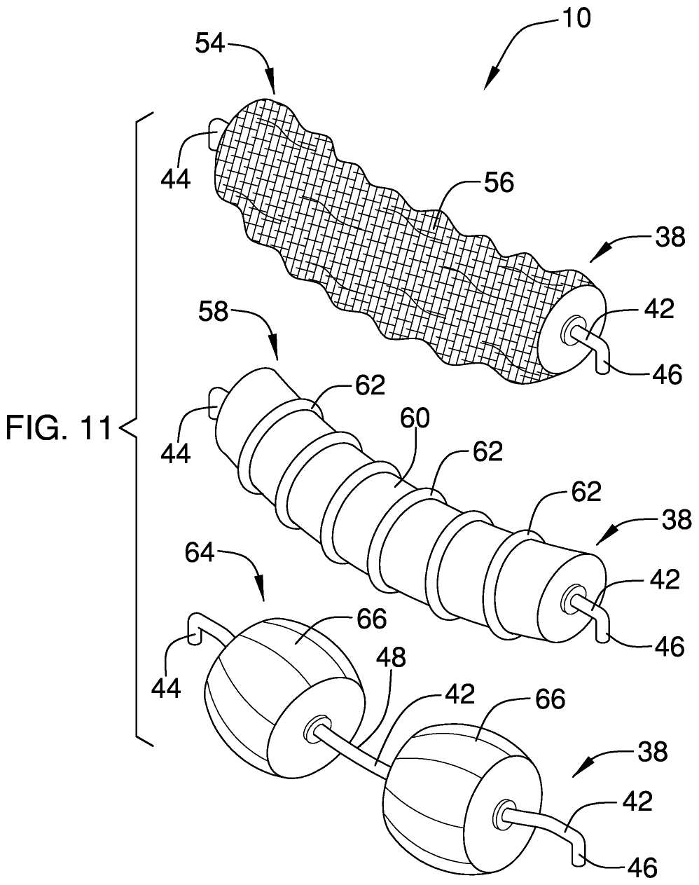

FIG. 12 is a kit view of some of the plurality of back engagement members of an embodiment of the disclosure.

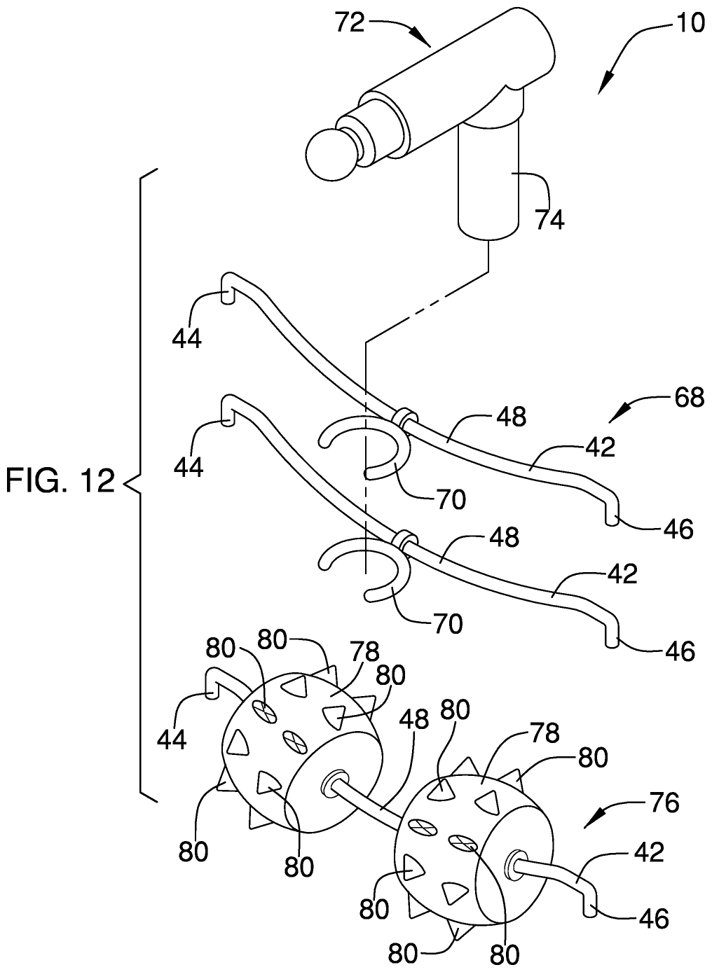

FIG. 13 is a kit view of one of the plurality of back engagement members of an embodiment of the disclosure.

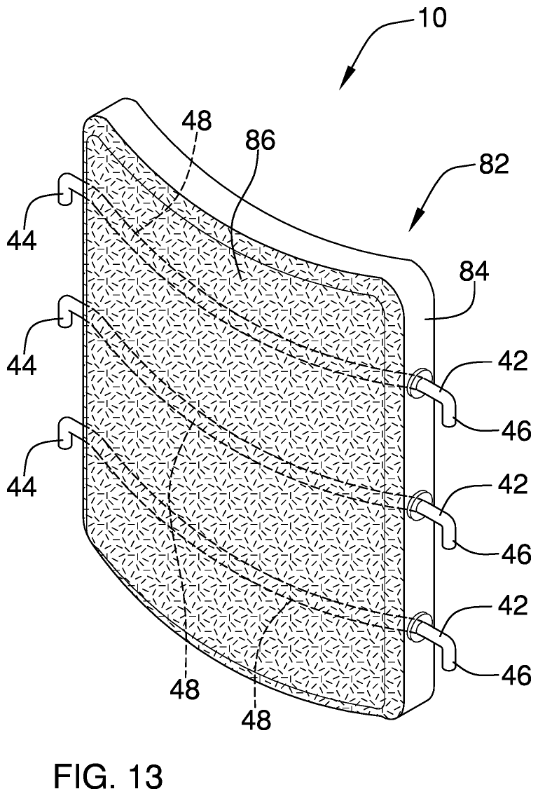

FIG. 14 is a kit view of one of the plurality of back engagement members of an embodiment of the disclosure.

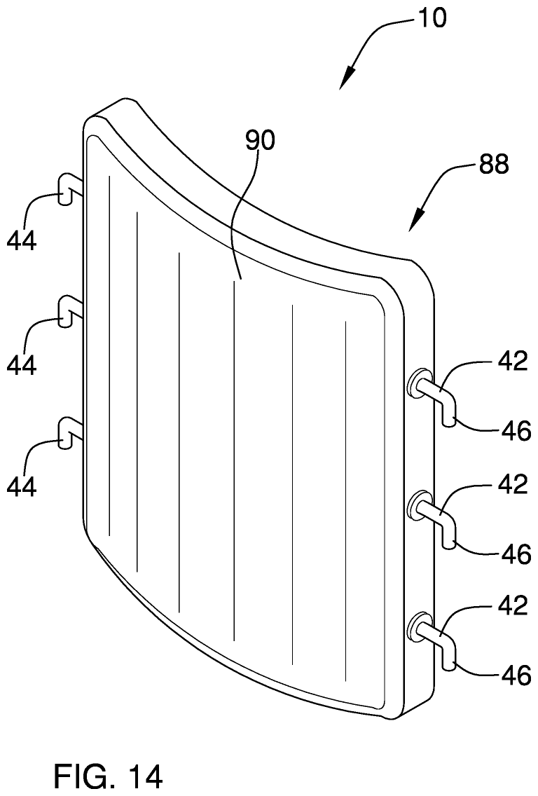

### DETAILED DESCRIPTION OF THE INVENTION

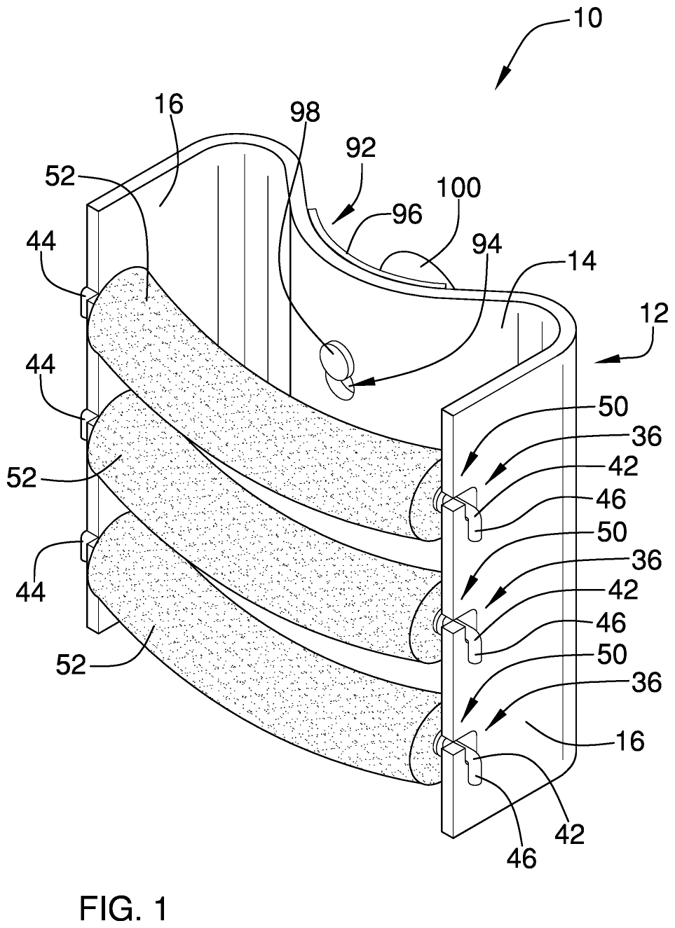

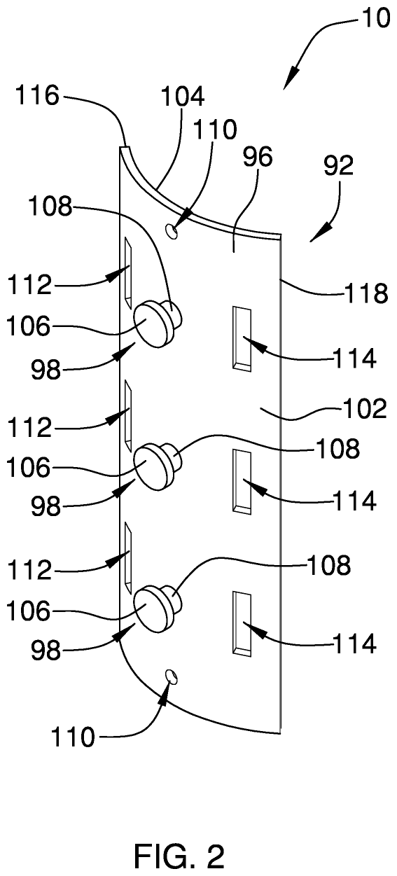

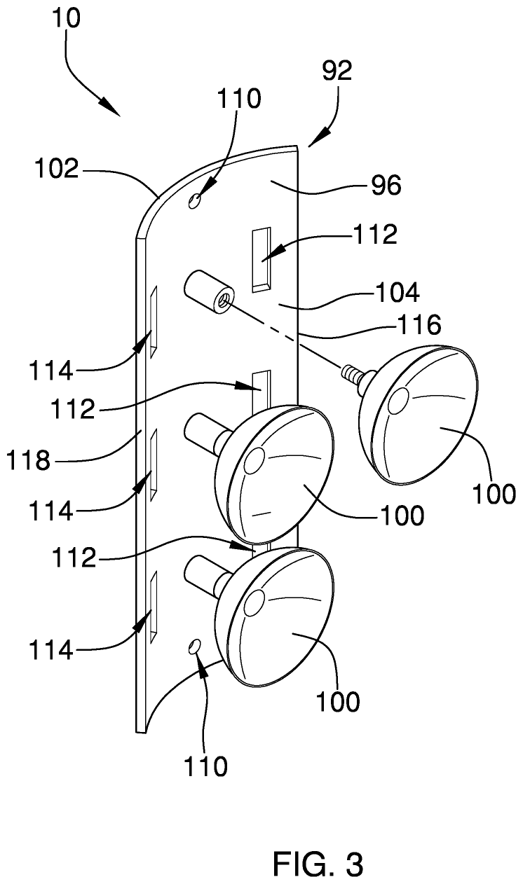

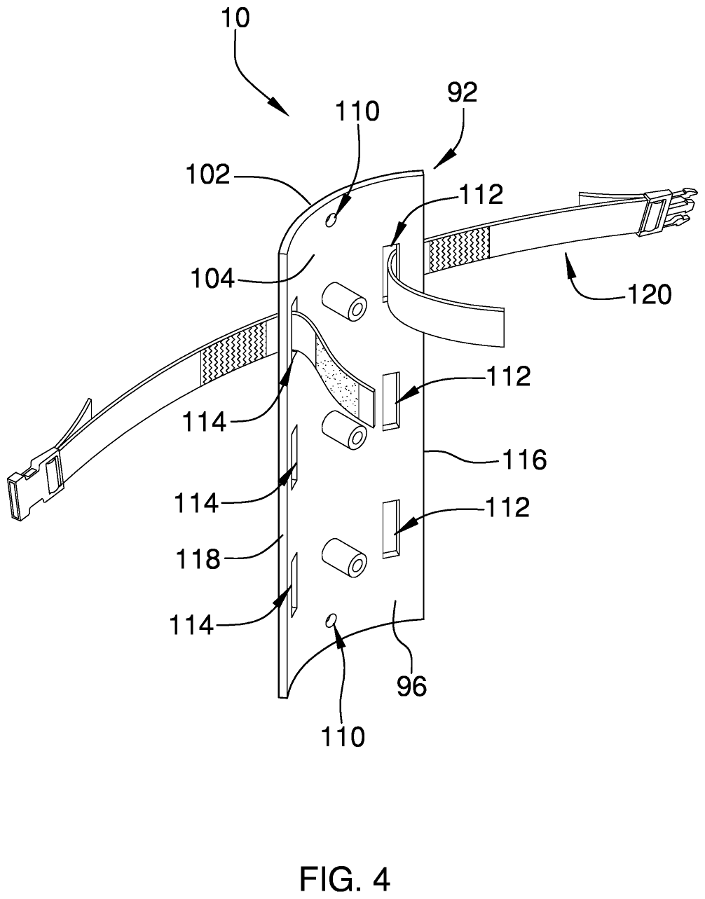

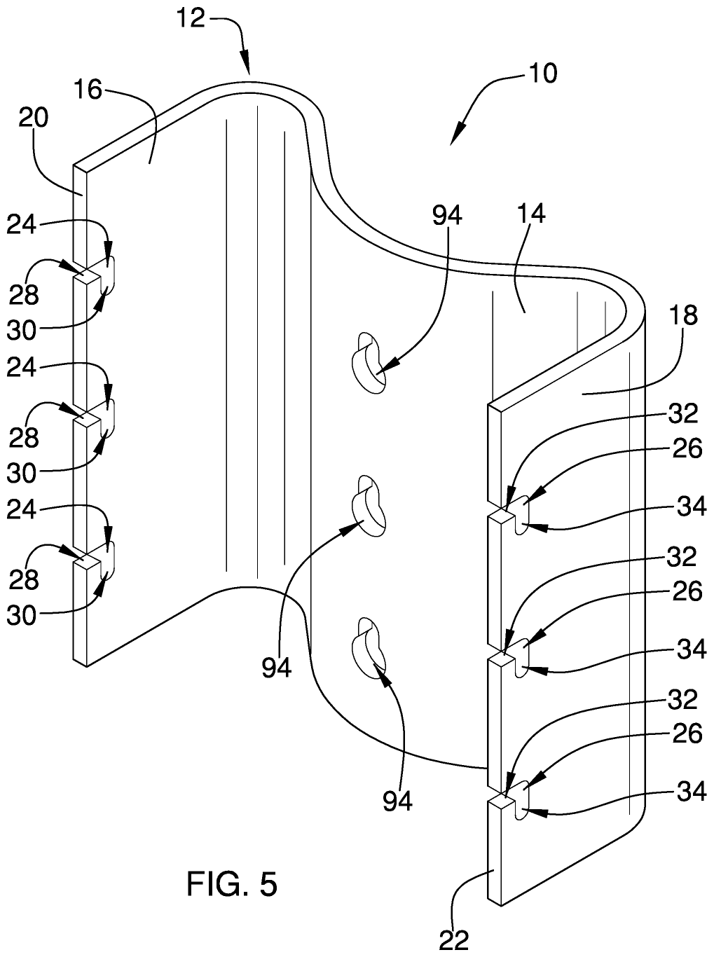

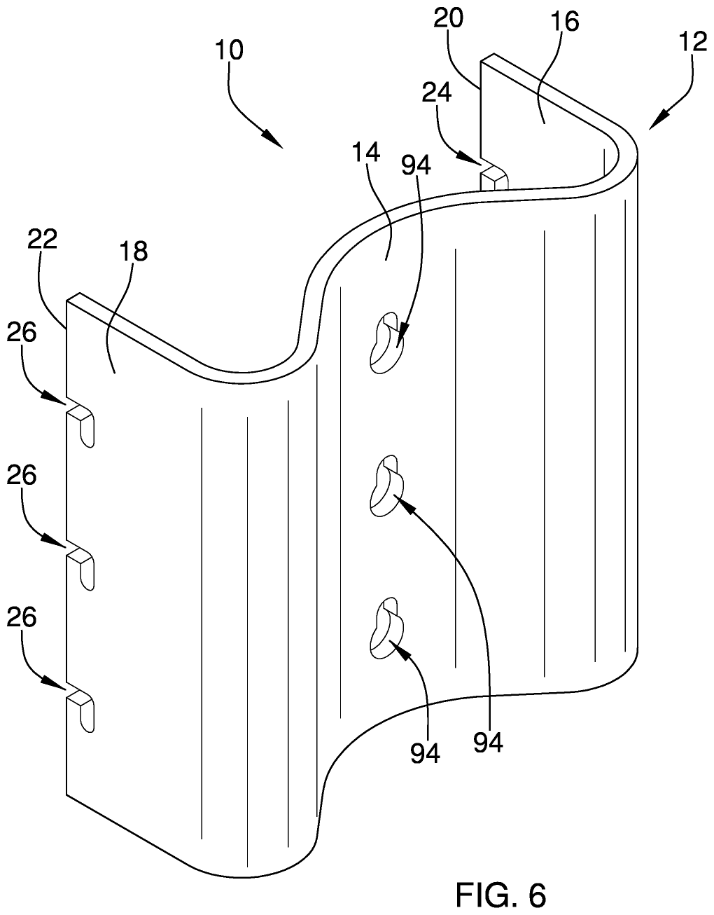

With reference now to the drawings, and in particular to FIGS. 1 through 6 thereof, a new back treatment apparatus embodying the principles and concepts of an embodiment of the disclosure and generally designated by the reference numeral 10 will be described.

As best illustrated in FIGS. 1 through 6, the back treatment assembly 10 generally comprises a frame 12 having a rear wall 14, a first lateral wall 16, and a second lateral wall 18. The rear wall 14 is coupled to and extends between the first and second lateral walls 16, 18, and each of the first and second lateral walls 16, 18 extends forwardly from the rear wall 14. The first lateral wall 16 has a plurality of first slots 24 extending into a front edge 20 of the first lateral wall 16, and the second lateral wall 18 has a plurality of second slots 26 extending into a front edge 22 of the second lateral wall 18. Each first slot 24 of the plurality of slots is horizontally aligned with an associated second slot 26 of the plurality of second slots 26. Each first slot 24 of the plurality of first slots 24 has an L-shape, wherein a first portion 28 of the first slot 24 extends rearwardly from the front edge 20 of the first lateral wall 16 and a second portion 30 of the first slot 24 extends downwardly from the first portion 28 of the first slot 24. Each second slot 26 of the plurality of second slots 26 also has an L-shape, wherein a first portion 36 of the second slot 26 extends rearwardly from the front edge 22 of the second lateral wall 18 and a second portion 34 of the second slot 26 extends downwardly from the first portion 36 of the second slot 26.

Each of a plurality of back engagement members 36 is interchangeably mountable to the frame 12 such that the back engagement member 36 is configured to abut a back 40 of a user 38. Each back engagement member 36 of the plurality of back engagement members 36 extends between the first and second lateral walls 16, 18 and engages a selected one of the plurality of first slots 24 and the associated second slot 26 when mounted to the frame 12. Each back engagement member 36 of the plurality of engagement members comprises at least one rod 42. The at least one rod 42 has a first hooked end 44 and a second hooked end 46. The first hooked end 44 engages the selected first slot 24 and the second hooked end 46 engages the associated second slot 26 when the back engagement member 36 is mounted to the frame 12. The at least one rod 42 has a rear side 48 which is concavely arcuate and faces the rear wall 14 when the back engagement member 36 is mounted to the frame 12.

The plurality of back engagement members 36 includes a sponge engagement member 50, a bath pouf engagement member 54, a ribbed roller engagement member 58, a spaced roller engagement member, a pair of massage gun engagement members, a spiked wheel engagement member, an exfoliating pad engagement member, and a heat transfer engagement member. The sponge engagement member 50 comprises a sponge 52 rotatably mounted around the at least one rod 42 of the sponge engagement member 50. The bath pouf engagement member 54 comprises a bath pouf 56 mounted around the at least one rod 42 of the bath pouf engagement member 54. “Bath pouf” as used in the specification and the claims refers to an article for cleaning and exfoliating skin comprising of a mesh net. Bath pouf are also commonly referred to as loofahs, though the term “loofah” can also refer to a tropical or subtropical vine, the fruit of which is commonly processed and used as a bathroom or kitchen sponge. The ribbed roller engagement member 58 comprises an elongated roller 60 and a plurality of ribs 62. The elongated roller 60 is rotatably mounted around and extends along the at least one rod 42 of the ribbed roller engagement member 58, and the plurality of ribs 62 is dispersed along a length of the elongated roller 60.

The spaced roller engagement member 64 comprises a pair of spaced rollers 66. each of which is rotatably mounted around the at least one rod 42 of the spaced roller engagement member 64. Each massage gun engagement member 68 of the pair of massage gun engagement members 68 has a clip 70 mounted to the at least one rod 42 of the massage gun engagement member 68 which has a C-shape and has a size such that the clip 70 is configured for grasping a handle 74 of a percussion massage gun 72. Some embodiments of the massage gun engagement member 68 may include only one rod 42. The spiked wheel engagement member 76 comprises a pair of spaced wheels 78, each of which is rotatably mounted around the at least one rod 42 of the spiked wheel engagement member 76. A plurality of pointed protrusions 80 is coupled to and extends radially outwardly from each one of the pair of spaced wheels 78.

The at least one rod 42 of the exfoliating pad engagement member 82 comprises a plurality of vertically spaced rods 42, and the exfoliating pad engagement member 82 comprises a pad 84 which is mounted around each one of the plurality of vertically spaced rods 42 of the exfoliating pad engagement member 82. The pad 84 has an engagement surface 86 which faces away from the rear wall 14 of the frame 12 when the exfoliating pad engagement member 82 is mounted to the frame 12. The engagement surface 86 is textured such that the engagement surface 86 is configured for abrading the back 40 of the user 38. The at least one rod 42 of the heat transfer engagement member 88 also comprises a plurality of vertically spaced rods 42, and the heat transfer engagement member 88 comprises a body 90 which is mounted around each one of the plurality of vertically spaced rods 42 of the heat transfer engagement member 88. The body 90 comprises a heat transfer medium material configured for alternately heating and cooling the back 40 of the user 38. The heat transfer medium material may include a refrigerant gel or other conventional material which may be heated or cooled as desired such that the back 40 of the user 38 is heated or cooled respectively when the heat transfer engagement member 88 abuts the back 40.

A mount assembly 92 is selectively engageable with the frame 12 and is configured for mounting the frame 12 to one of an external wall 122 and a column. The rear wall 14 of the frame 12 has a plurality of mounting holes 94 extending therethrough for mounting the frame 12 to the mount assembly 92. The mounting holes 94 of the plurality of mounting holes 94 are vertically spaced from each other. The mount assembly 92 comprises a base 96, a plurality of pegs 98, and a plurality of suction cups 100. The plurality of pegs 98 is coupled to and extends away from a front surface 102 of the base 96. Each peg 98 of the plurality of pegs 98 is engageable with an associated one of the plurality of mounting holes 94 of the rear wall 14 of the frame 12 to mount the frame 12 to the mount assembly 92. Each peg 98 of the plurality of pegs 98 has a head 106 and a neck 108, the neck 108 is coupled to and extends between the head 106 and the base 96.

The base 96 has a pair of openings 110 extending therethrough, each of which has a size such that the opening 110 is configured for facilitating mounting the base 96 to the external wall 122. The base 96 also has a plurality of first apertures 112 and a plurality of second apertures 114 extending therethrough. The first apertures 112 are vertically spaced from each other and are positioned adjacent to a first lateral edge 116 of the base 96. The second apertures 114 are also vertically spaced from each other and are positioned adjacent to a second lateral edge 118 of the base 96. Each one of the plurality of first apertures 112 and each one of the plurality of second apertures 114 has a size such that the first and second apertures 112, 114 are configured for receiving a strap 120 therethrough to facilitate mounting the base 96 to the column via the strap 120. The base 96 is arcuately curved about a vertical axis positioned rearwardly of the base 96. The base 96 is symmetrically shaped about a central vertical plane of the base 96. The plurality of pegs 98 is aligned along the central vertical plane of the base 96.

Each one of the plurality of suction cups 100 is removably couplable via a threaded connection to a rear surface 104 of the base 96. The plurality of suction cups 100 is configured for applying a suction force to mount the base 96 to the external wall 122.

In use, the mount assembly 92 is secured to one of the external wall 122 or the column, and the frame 12 is mounted to the mount assembly 92. One or more selected back engagement members 36 are attached to the frame 12, and the user 38 positions the user's 38 back 40 in abutment with the one or more selected back engagement members 36 to treat the user's 38 back 40. In some cases, the user 38 maneuver's the back 40 along the back engagement member 36 to scrub the user's 38 back 40. The sponge 52 of the sponge engagement member 50 may be caused to roll along the user's 38 back 40 and may be used to spread soap across the user's 38 back 40. The bath pouf 56 of the bath pouf engagement member 54 may also be used to spread soap across the user's 38 back 40.

The elongated roller 60 of the ribbed roller engagement member 58 and the pair of spaced rollers 66 of the spaced roller engagement member 64 may be caused to roll along the user's 38 back 40 to massage the back 40. The pair of massage gun engagement members 68 may engage the user's 38 back 40 via the percussion massage gun 72. The pair of spaced wheels 78 of the spiked wheel engagement may be caused to roll across the user's 38 back 40 to urge the pointed protrusions 80 against the user's 38 back 40 to scratch the user's 38 back 40. The exfoliating pad engagement member 82 is used to exfoliate the user's 38 back 40. The heat transfer engagement member 88 is used to heat or cool the user's 38 back 40 as desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A back treatment assembly comprising:
a frame comprising a rear wall, a first lateral wall, and a second lateral wall, the rear wall being coupled to and extending between the first and second lateral walls, each of the first and second lateral walls extending forwardly from the rear wall; and
a back engagement member being mounted to the frame, the back engagement member being positioned such that the back engagement member is configured to abut a back of a user, the back engagement member extending between the first and second lateral walls.

2. The assembly of claim 1, wherein the back engagement member is one of a plurality of back engagement members, the plurality of back engagement members being interchangeably mounted to the frame, each back engagement member of the plurality of back engagement members being positioned when mounted to the frame configured to abut the back of the user, each back engagement member of the plurality of back engagement members extending between the first and second lateral walls when mounted to the frame.

3. The assembly of claim 2, wherein:
the first lateral wall has a plurality of first slots extending into a front edge of the first lateral wall, the second lateral wall having a plurality of second slots extending into a front edge of the second lateral wall, each first slot of the plurality of slots being horizontally aligned with an associated second slot of the plurality of second slots; and
each back engagement member of the plurality of back engagement members engaging a selected one of the plurality of first slots and the associated second slot when mounted to the frame.

4. The assembly of claim 3, wherein each first slot of the plurality of first slots has an L-shape, a first portion of the first slot extending rearwardly from the front edge of the first lateral wall, a second portion of the first slot extending downwardly from the first portion of the first slot, each second slot of the plurality of second slots having an L-shape, a first portion of the second slot extending rearwardly from the front edge of the second lateral wall, a second portion of the second slot extending downwardly from the first portion of the second slot.

5. The assembly of claim 3, wherein each back engagement member of the plurality of engagement members comprises at least one rod which engages the selected first slot and the selected second slot when the back engagement member is mounted to the frame.

6. The assembly of claim 5, wherein the at least one rod has a first hooked end and a second hooked end, the first hooked end engaging the selected first slot and the second hooked end engaging the associated second slot when the back engagement member is mounted to the frame.

7. The assembly of claim 5, wherein the at least one rod has a rear side being concavely arcuate and faces the rear wall when the back engagement member is mounted to the frame.

8. The assembly of claim 5, wherein the plurality of back engagement members includes a sponge engagement member comprising a sponge rotatably mounted around the at least one rod of the sponge engagement member.

9. The assembly of claim 5, wherein the plurality of back engagement members includes a bath pouf engagement member comprising a bath pouf mounted around the at least one rod of the bath pouf engagement member, the bath pouf comprising a mesh net.

10. The assembly of claim 5, wherein the plurality of back engagement members includes a ribbed roller engagement member comprising an elongated roller and a plurality of ribs, the elongated roller being rotatably mounted around and extending along the at least one rod of the ribbed roller engagement member, the plurality of ribs being dispersed along a length of the elongated roller.

11. The assembly of claim 5, wherein the plurality of back engagement members includes a spaced roller engagement member comprising a pair of spaced rollers being rotatably mounted around the at least one rod of the spaced roller engagement member.

12. The assembly of claim 5, wherein the plurality of back engagement members includes a pair of massage gun engagement members, each massage gun engagement member of the pair of massage gun engagement members having a clip mounted to the at least one rod of the massage gun engagement member, the clip having a C-shape and having a size such that the clip is configured for grasping a handle of a percussion massage gun.

13. The assembly of claim 5, wherein the plurality of back engagement members includes a spiked wheel engagement member comprising a pair of spaced wheels being rotatably mounted around the at least one rod of the spiked wheel engagement member, a plurality of pointed protrusions being coupled to and extending radially outwardly from each one of the pair of spaced wheels.

14. The assembly of claim 5, wherein the plurality of back engagement members includes an exfoliating pad engagement member, the at least one rod of the exfoliating pad engagement member comprising a plurality of vertically spaced rods, the exfoliating pad engagement member comprising a pad being mounted around each one of the plurality of vertically spaced rods of the exfoliating pad engagement member, the pad having an engagement surface facing away from the rear wall of the frame when the exfoliating pad engagement member is mounted to the frame, the engagement surface being textured such that the engagement surface is configured for abrading the back of the user.

15. The assembly of claim 5, wherein the plurality of back engagement members includes a heat transfer engagement member, the at least one rod of the heat transfer engagement member comprising a plurality of vertically spaced rods, the heat transfer engagement member comprising a body being mounted around each one of the plurality of vertically spaced rods of the heat transfer engagement member, the body comprising a heat transfer medium material configured for alternately heating and cooling the back of the user.

16. The assembly of claim 1, further comprising a mount assembly being selectively engageable with the frame and being configured for mounting the frame to one of an external wall and a column.

17. The assembly of claim 16, wherein:
the rear wall of the frame has a plurality of mounting holes extending therethrough, the plurality of mounting holes being vertically spaced from each other; and
the mount assembly comprises:
a base; and
a plurality of pegs being coupled to and extending away from a front surface of the base, each peg of the plurality of pegs being engageable with an associated one of the plurality of mounting holes of the rear wall of the frame to mount the frame to the mount assembly, the plurality of pegs being aligned along the central vertical plane of the base, each peg of the plurality of pegs having a head and a neck, the neck being coupled to and extending between the head and the base.

18. The assembly of claim 16, wherein the base of the mount assembly has a pair of openings extending therethrough, each opening of the pair of openings having a size such that the opening is configured for facilitating mounting the base to the external wall, the base having a plurality of first apertures and a plurality of second apertures extending therethrough, the plurality of first apertures being vertically spaced from each other and being positioned adjacent to a first lateral edge of the base, the plurality of second apertures being vertically spaced from each other and being positioned adjacent to a second lateral edge of the base, each one of the plurality of first apertures and each one of the plurality of second apertures having a size such that the first and second apertures are configured for receiving a strap therethrough to facilitate mounting the base to the column via the strap.

19. The assembly of claim 16, wherein:
the base is arcuately curved about a vertical axis positioned rearwardly of the base, the base being symmetrically shaped about a central vertical plane of the base; and
the mount assembly further comprises a plurality of suction cups, each one of the plurality of suction cups being removably couplable to a rear surface of the base, each suction cup of the plurality of suction cups having a threaded connection with the base, the plurality of suction cups being configured for applying a suction force to mount the base to the external wall.

20. A back treatment assembly comprising:
a frame comprising a rear wall, a first lateral wall, and a second lateral wall, the rear wall being coupled to and extending between the first and second lateral walls, each of the first and second lateral walls extending forwardly from the rear wall, the first lateral wall having a plurality of first slots extending into a front edge of the first lateral wall, the second lateral wall having a plurality of second slots extending into a front edge of the second lateral wall, each first slot of the plurality of slots being horizontally aligned with an associated second slot of the plurality of second slots, each first slot of the plurality of first slots having an L-shape, a first portion of the first slot extending rearwardly from the front edge of the first lateral wall, a second portion of the first slot extending downwardly from the first portion of the first slot, each second slot of the plurality of second slots having an L-shape, a first portion of the second slot extending rearwardly from the front edge of the second lateral wall, a second portion of the second slot extending downwardly from the first portion of the second slot, the rear wall having a plurality of mounting holes extending therethrough, the plurality of mounting holes being vertically spaced from each other;
a plurality of back engagement members, each back engagement member of the plurality of back engagement members being interchangeably mountable to the frame, each back engagement member being positioned when mounted to the frame such that the back engagement member is configured to abut a back of a user, each back engagement member of the plurality of back engagement members extending between the first and second lateral walls when mounted to the frame, each back engagement member of the plurality of back engagement members engaging a selected one of the plurality of first slots and the associated second slot when mounted to the frame, each back engagement member of the plurality of engagement members comprising at least one rod having a first hooked end and a second hooked end, the first hooked end engaging the selected first slot and the second hooked end engaging the associated second slot when the back engagement member is mounted to the frame, the at least one rod having a rear side being concavely arcuate and facing the rear wall when the back engagement member is mounted to the frame, the plurality of back engagement members including:
a sponge engagement member comprising a sponge rotatably mounted around the at least one rod of the sponge engagement member;
a bath pouf engagement member comprising a bath pouf mounted around the at least one rod of the bath pouf engagement member, the bath pouf comprising a mesh net;
a ribbed roller engagement member comprising an elongated roller and a plurality of ribs, the elongated roller being rotatably mounted around and extending along the at least one rod of the ribbed roller engagement member, the plurality of ribs being dispersed along a length of the elongated roller;
a spaced roller engagement member comprising a pair of spaced rollers being rotatably mounted around the at least one rod of the spaced roller engagement member;
a pair of massage gun engagement members, each massage gun engagement member of the pair of massage gun engagement members having a clip mounted to the at least one rod of the massage gun engagement member, the clip having a C-shape and having a size such that the clip is configured for grasping a handle of a percussion massage gun;
a spiked wheel engagement member comprising a pair of spaced wheels being rotatably mounted around the at least one rod of the spiked wheel engagement member, a plurality of pointed protrusions being coupled to and extending radially outwardly from each one of the pair of spaced wheels;
an exfoliating pad engagement member, the at least one rod of the exfoliating pad engagement member comprising a plurality of vertically spaced rods, the exfoliating pad engagement member comprising a pad being mounted around each one of the plurality of vertically spaced rods of the exfoliating pad engagement member, the pad having an engagement surface facing away from the rear wall of the frame when the exfoliating pad engagement member is mounted to the frame, the engagement surface being textured such that the engagement surface is configured for abrading the back of the user; and
a heat transfer engagement member, the at least one rod of the heat transfer engagement member comprising a plurality of vertically spaced rods, the heat transfer engagement member comprising a body being mounted around each one of the plurality of vertically spaced rods of the heat transfer engagement member, the body comprising a heat transfer medium material configured for alternately heating and cooling the back of the user; and
a mount assembly being selectively engageable with the frame and being configured for mounting the frame to one of an external wall and a column, the mount assembly comprising:
a base, the base having a pair of openings extending therethrough, each opening of the pair of openings having a size such that the opening is configured for facilitating mounting the base to the external wall, the base having a plurality of first apertures and a plurality of second apertures extending therethrough, the plurality of first apertures being vertically spaced from each other and being positioned adjacent to a first lateral edge of the base, the plurality of second apertures being vertically spaced from each other and being positioned adjacent to a second lateral edge of the base, each one of the plurality of first apertures and each one of the plurality of second apertures having a size such that the first and second apertures are configured for receiving a strap therethrough to facilitate mounting the base to the column via the strap, the base being arcuately curved about a vertical axis positioned rearwardly of the base, the base being symmetrically shaped about a central vertical plane of the base;
a plurality of pegs being coupled to and extending away from a front surface of the base, each peg of the plurality of pegs being engageable with an associated one of the plurality of mounting holes of the rear wall of the frame to mount the frame to the mount assembly, the plurality of pegs being aligned along the central vertical plane of the base, each peg of the plurality of pegs having a head and a neck, the neck being coupled to and extending between the head and the base; and
a plurality of suction cups, each one of the plurality of suction cups being removably couplable to a rear surface of the base, each suction cup of the plurality of suction cups having a threaded connection with the base, the plurality of suction cups being configured for applying a suction force to mount the base to the external wall.
